(19) United States
(12) Patent Application Publication
(10) Pub. No.: US 2011/0068693 A1
(43) Pub. Date: Mar. 24, 2011

(54) LIGHTING APPARATUS AND THE METHOD FOR USING THE SAME

(75) Inventor: Hsiang Lin HSU, Taoyuan County (TW)

(73) Assignee: STARCHIPS TECHNOLOGY INC., Hsin-Chu (TW)

(21) Appl. No.: 12/698,317

(22) Filed: Feb. 2, 2010

(30) Foreign Application Priority Data
Sep. 18, 2009 (TW) 098131473

(51) Int. Cl. H05B 37/00; H05B 37/02

(52) U.S. Cl. 315/119; 315/294; 315/192

(57) ABSTRACT

A lighting apparatus receives a regulated AC line voltage as an input voltage and comprises a light emitting diode array and a driving circuit. The light emitting diode array is composed of at least one light emitting diode set connected in parallel. The driving circuit has a plurality of outputs corresponding to the light emitting diode sets, and each output has a predetermined value for controlling the brightness of the light emitting diode set. Each light emitting diode set is conducted automatically and in sequence for a fixed time interval based on the output of the driving circuit and the amplitude of the regulated AC line voltage, and is turned off based on the predetermined signal of the driving circuit.

### BACKGROUND OF THE INVENTION

1. Field of the Invention

The present invention relates to a lighting apparatus and method for using the same, and more particularly to an apparatus that is powered by a regulated AC power or a DC power.

2. Description of the Related Art

Due to their low power consumption, high brightness, small volume and long life, light emitting diodes (LED) have become widely applied in the lighting field. Among a variety of LED applications, most are powered by a DC voltage regulated from a normal AC power, such as 110V, 60 Hz. FIG. 1 shows a conventional power supply 10 which is composed of a DC-DC converter or a switched regulator. Referring to FIG. 1, the power supply 10 receives an AC power input first, and then filters noise through a bridge rectifier 12 and a capacitor C_{filter} to provide a non-regulated DC voltage as the input voltage Vᵢₙ of the DC-DC converter 14. The DC-DC converter 14 may be a forward converter for performing a voltage drop. The converter 14 includes a transformer 142, diodes D1 and D2, an inductor L and a capacitor C. The converter 14 further includes an isolator 144 for forwarding error signals Vₑᵣᵣₒᵣ from the error amplifier 146 to the modulator 148.

Due to the switching characteristic of the DC-DC converter, the above converter extracts current from the power source in a pulse-by-pulse manner, thus causing some drawbacks, such as a reduction of the power factor. To achieve the optimization of efficiency of the AC power, the input current extracted from the AC power would ideally be in the sine wave form and in phase with the AC power. Such so-called unity power factor is usually generated in a pure loading condition. However, the characteristic of the above DC-DC converter and generated pulse current extraction results in the power factor of the apparatus in FIG. 1 being less than the unity power factor, and thus does not satisfy the demand of optimized power efficiency. In addition, the capacitor C_{filter} between the bridge rectifier 12 and the DC-DC converter 14 further weakens the power factor.

Taiwan Patent Number I220047 discloses an LED driving circuit, which can directly drive the LED in the positive cycle of the supply voltage without filtering capacitors. FIG. 2 shows the structure of the LED driving circuit. Referring to FIG. 2, the driving circuit comprises a power supply Vₛ, a bridge rectifier 22, a current-oriented control circuit 24 composed of a plurality of current control units I₁-Iₙ, and a voltage detecting circuit 20 used to detect the voltage level of the power supply Vₛ. When the AC voltage is determined by the voltage detecting circuit 20 to be greater than the threshold voltage of the diode D₁, the current control unit I₁ is activated to turn on the LED D₁. Next, when the AC voltage is determined by the voltage detecting circuit 20 to be greater than the threshold voltage of the diode D₁ and diode D₂, the current control unit I₁ is off and another current control unit I₂ is activated to turn on the diodes D₁ and D₂. Under such a structure, since the diodes D₁-Dₙ are repeatedly turned on in different current paths, if a pulse width modulation is used to control the brightness, the design of the current-oriented control circuit 24 is complicated, and D₁-Dₙ fail to have the same brightness level.

To achieve maximum efficiency of the AC power and to provide a uniform and adjustable light source, it is necessary to propose a lighting apparatus and method to meet the demand of the market.

### SUMMARY OF THE INVENTION

The lighting apparatus in accordance with one embodiment of the present invention receives an AC power as its input power and comprises an LED array and a driving circuit. The LED array has a plurality of LED sets connected in parallel. The driving circuit includes a plurality of outputs corresponding to the LED sets, and each of the outputs has a predetermined value to control the brightness of the corresponding LED set. Each of the LED sets is turned on in sequence in accordance with the output of the driving circuit and the amplitude of the regulated AC power, and is turned off in accordance with the predetermined value.

The lighting apparatus in accordance with one embodiment of the present invention receives a DC power as its input power and comprises an LED array and a driving circuit. The LED array has a plurality of LED sets connected in parallel. The driving circuit includes a plurality of outputs corresponding to the LED sets to control the brightness of the corresponding LED set. Each of the LED sets is selectively turned on in accordance with the output of the driving circuit and is turned off in accordance with a predetermined value of the output of the driving circuit, and the LED sets are arranged in accordance with the number of LED components in the LED set in descending order or ascending order.

The present invention proposes a lighting method for turning on an LED array in sequence. The LED array receives an AC power as an input power, and has a plurality of LED sets connected in parallel. The method comprises the steps of: providing a first LED set with a first driving signal; turning on the first LED set in accordance with a first amplitude of the AC power; cutting off the current of the first LED set when the current of the first LED set reaches a first predetermined value; providing a second LED set with a second driving signal; turning on the second LED set in accordance with a second amplitude of the AC power; and cutting off the current of the second LED set when the current of the second LED set reaches a second predetermined value. The number of LED components in the first LED set is less than the number of LED components in the second LED set when the first amplitude is less than the second amplitude, while the number of LED components in the first LED set is greater than the number of LED components in the second LED set when the first amplitude is greater than the second amplitude.

The present invention proposes a lighting method for turning on an LED array in sequence. The LED array receives a DC power as an input power, and the LED array has a plurality of LED sets connected in parallel. The method comprises the steps of: turning on a first LED set in accordance with an enable signal; cutting off the current of the first LED set when the current of the first LED set reaches a first predetermined value; turning on a second LED set in accordance with a first timing signal; cutting off the current of the second LED set when the current of the second LED set reaches a second predetermined value; and turning on a third LED set in accordance with a second timing signal. The number of LED components connected in series in each of the first, second and third LED sets is in descending order or ascending order.

### BRIEF DESCRIPTION OF THE DRAWINGS

The invention will be described according to the appended drawings in which:

FIG. 1 shows a conventional power supply which is composed of a DC-DC converter or a switched regulator;

FIG. 2 shows a structure of the LED driving circuit;

FIG. 3 shows a block diagram of the lighting apparatus incorporating a power supply device in accordance with one embodiment of the present invention;

FIG. 4 shows a flow chart of serially turning on an LED array in accordance with one embodiment of the present invention;

FIG. 5 shows the timing of a turn-on sequence;

FIG. 6 shows another structure of an LED array in accordance with one embodiment of the present invention;

FIG. 7 shows an arrangement of LED bars in an LED array in accordance with one embodiment of the present invention;

FIG. 8 shows another arrangement of LED bars in an LED array in accordance with one embodiment of the present invention;

FIG. 9 shows another structure in contrast to the structure in FIG. 3;

FIG. 10 shows a turn-on timing of an LED array in accordance with the AC power;

FIG. 11 shows a structure diagram of a lighting apparatus in accordance with one embodiment of the present invention; and

FIG. 12 shows a flow chart of serially turning on the LED array in accordance with one embodiment of the present invention.

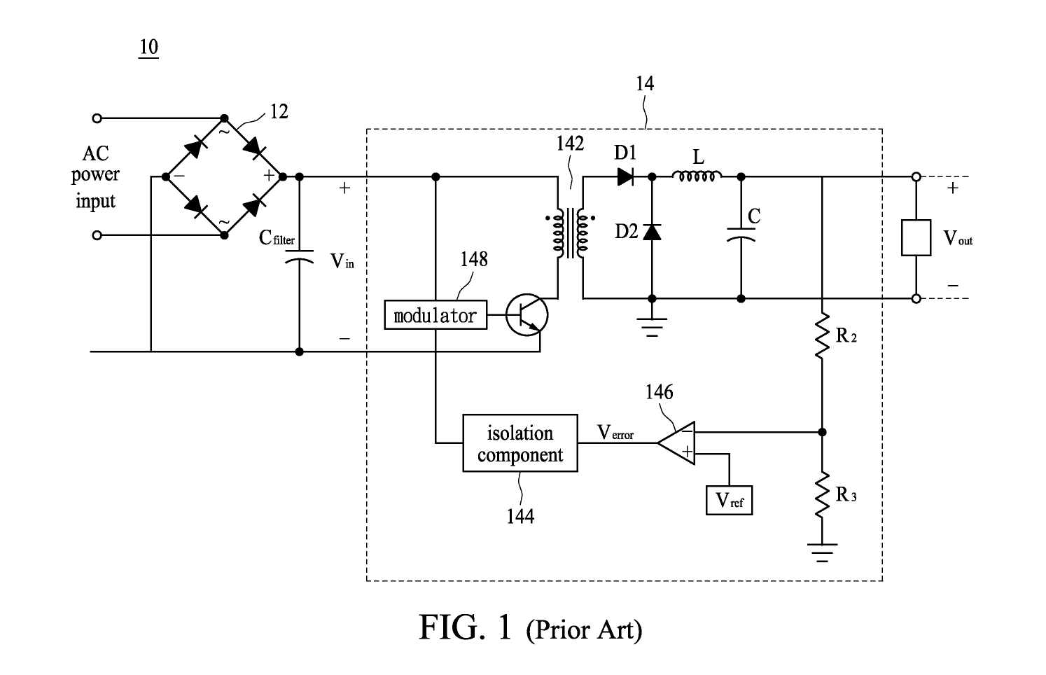

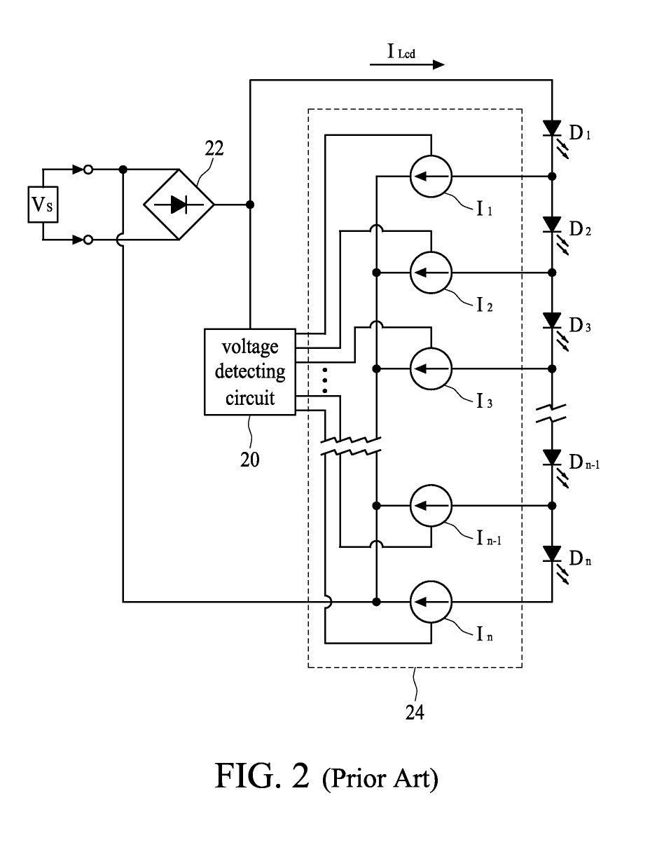

### PREFERRED EMBODIMENT OF THE PRESENT INVENTION

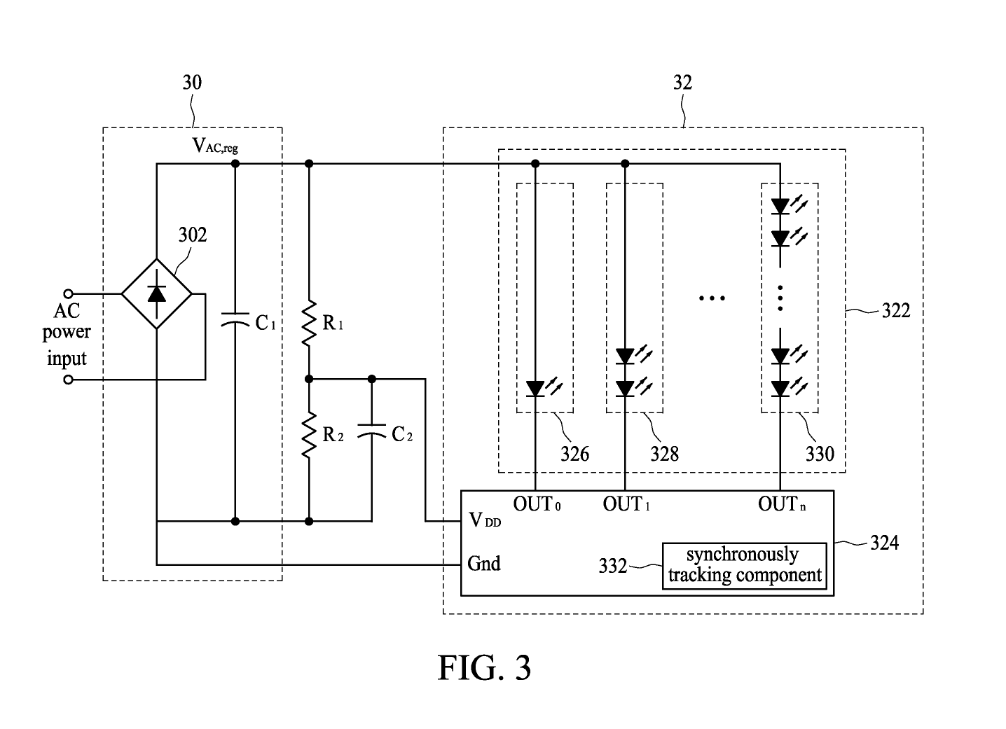

FIG. 3 shows a block diagram of the lighting apparatus 32 incorporating a power supply device 30 in accordance with one embodiment of the present invention. The lighting apparatus 32 receives an AC power V_{AC,reg} regulated by the power supply device 30 as the input power thereof. The power supply device 30 includes a rectifier 302 for receiving an AC power input. To supply a positive voltage of the lighting apparatus 32, the rectifier 302 can be a full-wave rectifier or a half-wave rectifier. The power supply device 30 can also include a capacitor C₁ coupled to the rectifier 302 for filtering high-frequency noises of the AC power input.

Referring to FIG. 3, the lighting apparatus 32 includes an LED array 322 and a driving circuit 324. In one embodiment, the LED array 322 is assembled in parallel with a plurality of LED bars 326, 328 and 330, and each LED bar comprises a plurality of LED components connected in series. The driving circuit 324 includes a plurality of outputs OUT₀, OUT₁, . . . , OUTₙ, each corresponding to one LED bar, and used to control the brightness of the corresponding LED bar with a predetermined value. In one embodiment, the predetermined value is a fixed current value and a fixed turn-on duration. By changing the current and turn-on duration, the brightness of the LED bars can be efficiently adjusted.

Referring to FIG. 3, the power V_{DD} of the driving circuit 324 is derived from a divided voltage of the AC power V_{AC, reg} and a filter circuit. The divided voltage and filter circuit include resistors R₁, R₂ and C₂. Alternatively, the power V_{DD} of the driving circuit 324 is derived from a battery. In addition, each LED bar of the LED array 322 includes a resistor coupled to the AC power V_{AC, reg} and the driving circuit 324. The resistor is used to protect the normal operation of the LED bar, such as over-current or under-current protection. In one embodiment, each LED bar of the LED array 322 includes a switch component coupled to the AC power V_{AC, reg} and the driving circuit 324. The switch component is used to implement dimming control or to perform protection under an abnormal operation.

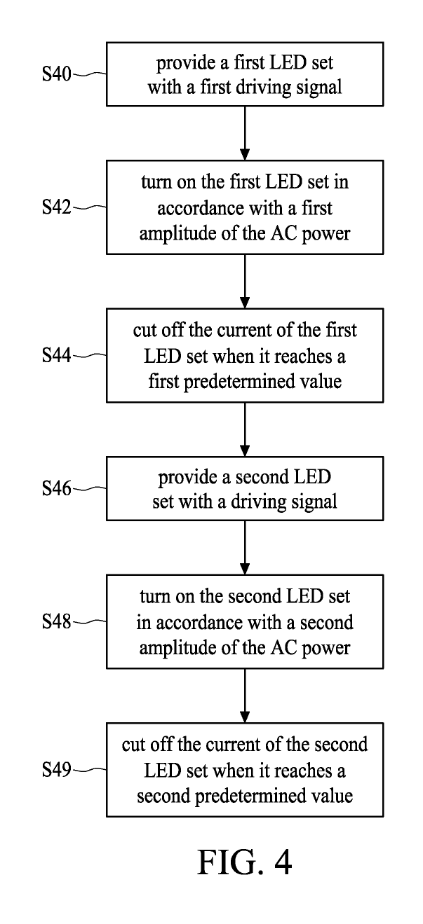

FIG. 4 shows a flow chart of serially turning on the LED array in accordance with one embodiment of the present invention, where the LED array receives a regulated AC power as an input power. In step S40, a first driving signal of a first LED set is provided. In step S42, the first LED set is turned on in accordance with the first amplitude of the AC power. In step S44, when the current of the first LED set reaches a first predetermined value, the current of the first LED set is cut off. In step S46, a second driving signal of a second LED set is provided. In step S48, the second LED set is turned on in accordance with the second amplitude of the AC power. In step S49, when the current of the second LED set reaches a second predetermined value, the current of the second LED set is cut off. It is noted that when the first amplitude is less than the second amplitude, the number of the LED components connected in series in the first LED set is less than the number of the LED components connected in series in the second LED set, while when the first amplitude is greater than the second amplitude, the number of the LED components connected in series in the first LED set is greater than the number of the LED components connected in series in the second LED set.

The following describes an operation of one embodiment of the present invention. First, a regulated AC power V_{AC, reg} is used to provide a power supply of the LED array 322, while the AC power V_{AC, reg} can be a full-wave rectifier or a half-wave rectifier. Next, following the amplitude of the AC power V_{AC, reg} and the turn-on sequence of the outputs OUT₀, OUT₁, . . . , OUTₙ, the LED bars 326, 328 and 330 are turned on in sequence.

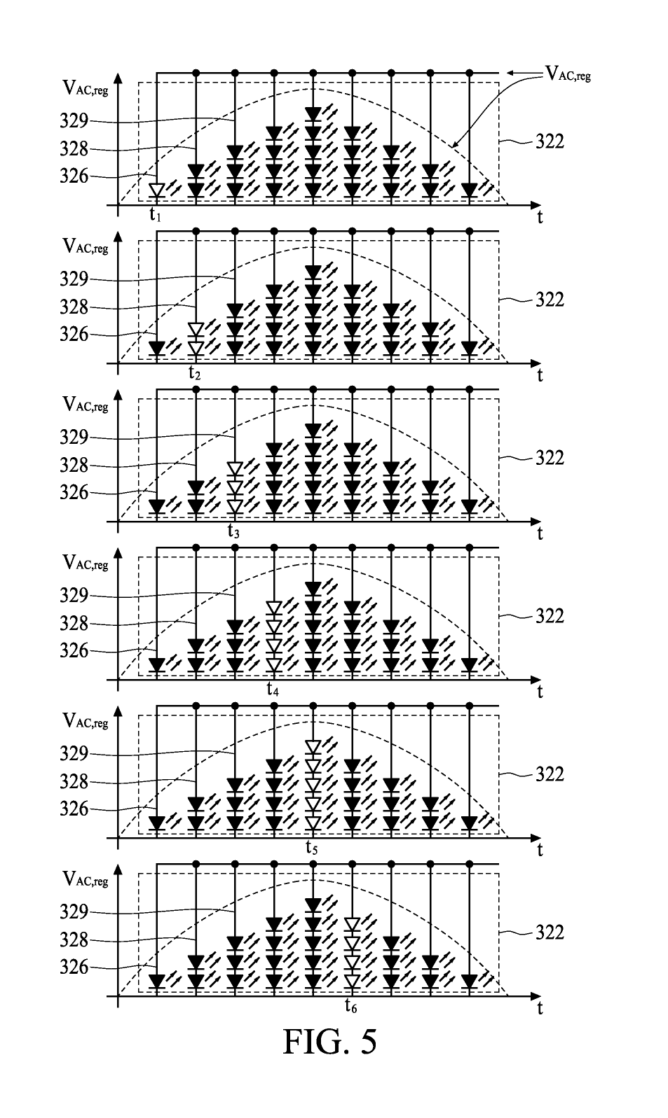

FIG. 5 shows the timing of a turn-on sequence. First, when t<t₁, the OUT₀ of the driving circuit 324 is activated, which represents that the first LED bar 326 is ready to be turned on. Next, when t=t₁, the amplitude of the AC power V_{AC, reg} is greater than the voltage drop of the LED components in the LED bar 326 and the voltage drop between OUT₀ of the driving circuit 324 and Gnd, and therefore the LED components in the LED bar 326 are turned on. Subsequently, when the current of the first LED bar 326 reaches a predetermined value of OUT₀ that is, the current of the LED bar 326 reaches the fixed current and fixed turn-on duration, the current of the first LED bar 326 is cut off. Meanwhile, the OUT₁ of the driving circuit 324 is activated, which represents that the second LED bar 328 can be turned on.

When t=t2, the amplitude of the AC power V_{AC, reg} is greater than the voltage drop of the serially-connected LEDs in the second LED bar and the voltage drop between the OUT1 of the driving circuit 324 and Gnd, and thus the second LED bar 328 is turned on and the LED components therein are turned on as well. When the current of the second LED bar 328 reaches a predetermined value of OUT₁, the current of the second LED bar 328 is cut off. Similarly, when t=t₃ to t₆, the LED array 322 is turned on or turned off in sequence in accordance with the amplitude of the AC power V_{AC, reg}, the status of OUT₀ OUT₁, . . . , OUTₙ of the driving circuit 324 and the predetermined value. Due to the function of the internal current detecting mechanism of the driving circuit 324, only a single LED bar or more are turned on each time, and thus the purpose of reducing entire power loss can be achieved. In addition, when the frequency of the input AC power is 60 Hz, each LED bar can be turned on in sequence 120 times per second. Because of the residual images in the human eye, the visual effect of the present invention is better than that of the conventional Cold Cathode Fluorescent Lamp (CCFL).

In addition, in one embodiment of the present invention, the driving circuit 324 includes a synchronous tracking unit 332, which is used to track the amplitude and cycle of the AC power V_{AC, reg} for adjusting the turn-on sequence and operating frequency of the OUT₀, OUT₁, . . . , OUTₙ. In one embodiment, the synchronous tracking unit 332 detects the first and second turn-on status of the first LED bar 326 to synchronously track the cycle of the AC power V_{AC, reg} for adjusting the operating frequency outputted by the driving circuit 324 to be consistent with the AC power V_{AC, reg}, and thus the turn-on sequence controlled by the driving circuit 324 is adjusted as well.

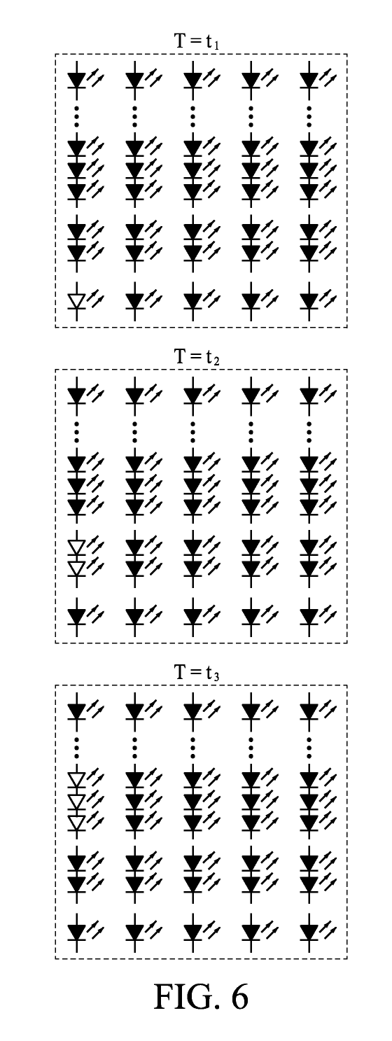

FIG. 6 shows another structure of an LED array in accordance with one embodiment of the present invention. In contrast to the LED array 322 in FIG. 5, in which the LED bars 326, 328 and 330 are arranged in accordance with the amplitude of the AC power V_{AC, reg}, the LED columns in FIG. 6 are cascaded in series by LED bars having the number of LED components from the least to the most, and the LED array is shaped like a rectangle. Alternatively, LED columns are cascaded in series by LED bars having the number of LED components from the most to the least.

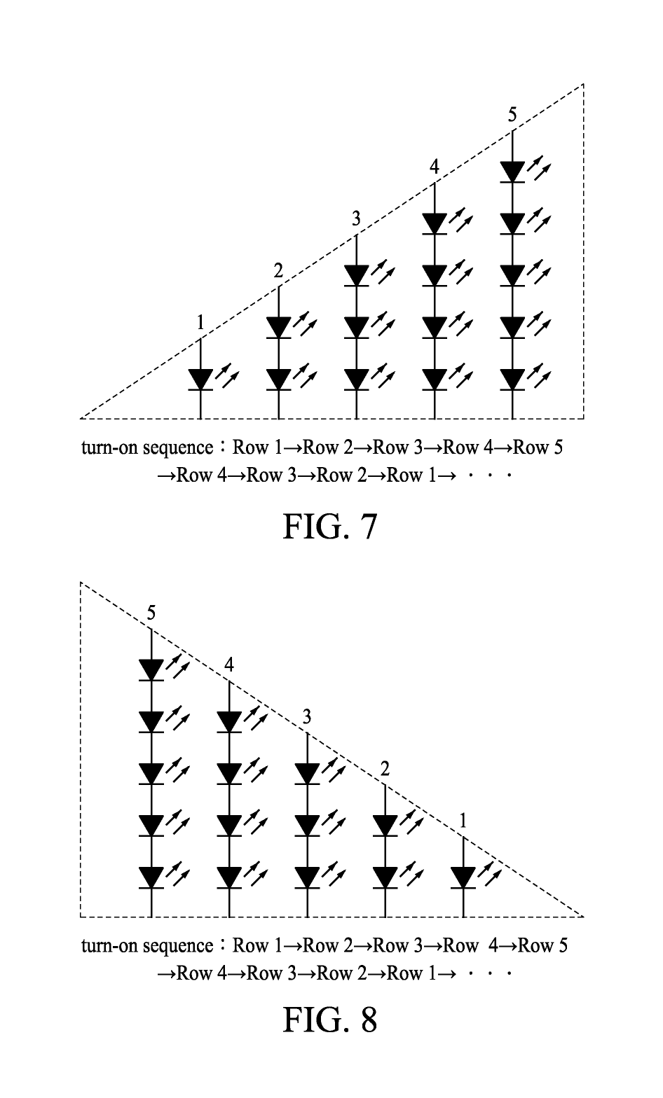

Furthermore, in another embodiment, the LED columns in FIG. 7 are cascaded in series by LED bars having the number of LED components from the least to the most, and the LED array is shaped like a triangle. Alternatively, the LED columns in FIG. 8 are cascaded in series by LED bars having the number of LED components from the most to the least.

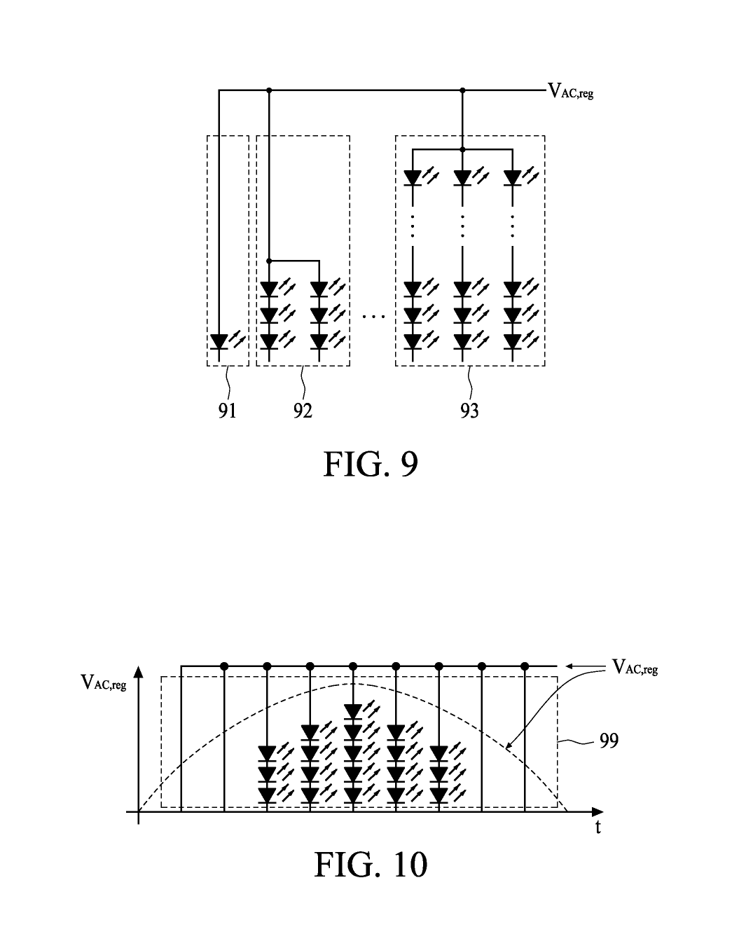

FIG. 9 shows another structure in contrast to the structure in FIG. 3, where an LED set 91 is assembled with a single LED bar, while an LED set 92 is assembled with two LED bars connected in parallel, each of which is assembled with three LED components. Namely, each LED set can be assembled with at least one LED bar connected in parallel, and the LED bar is assembled with at least one LED component connected in series.

In addition, the LED set in the LED array can be turned on not only in the fully positive voltage cycles of the AC power V_{AC, reg}, but also in the partially positive voltage cycles of the AC power V_{AC, reg}. FIG. 10 shows a turn-on timing of an LED array 99 in accordance with the AC power V_{AC, reg}. The turn-on range of each LED set of the LED array 99 is limited to the partially positive voltage cycle of the AC power V_{AC, reg}.

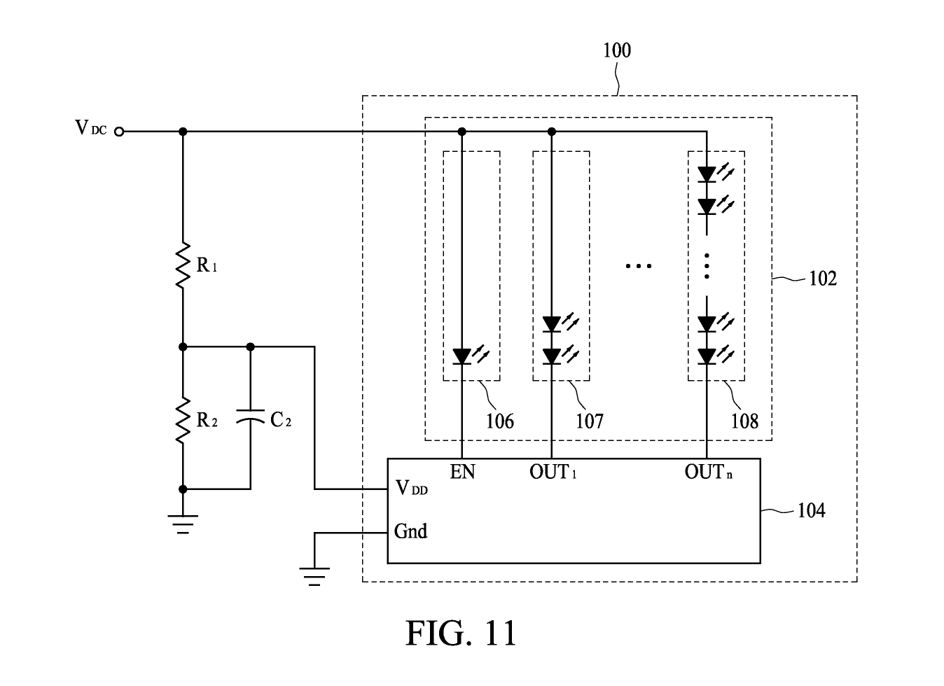

The lighting apparatus 32 in FIG. 3 receives a regulated AC power V_{AC, reg} from the power supply device 30 as an input power. However, the lighting apparatus 32 can also receive a DC power as its input power. FIG. 11 shows another structure of lighting apparatus 100 in accordance with one embodiment of the present invention. The lighting apparatus 100 receives a DC power supply V_{ic} from a battery, from a linear regulator, or from a DC-DC converter as an input power. Referring to FIG. 11, the LED apparatus 100 includes an LED array 102 and a driving circuit 104. The LED array 102 can be arranged like the structures shown in FIG. 5 to FIG. 8.

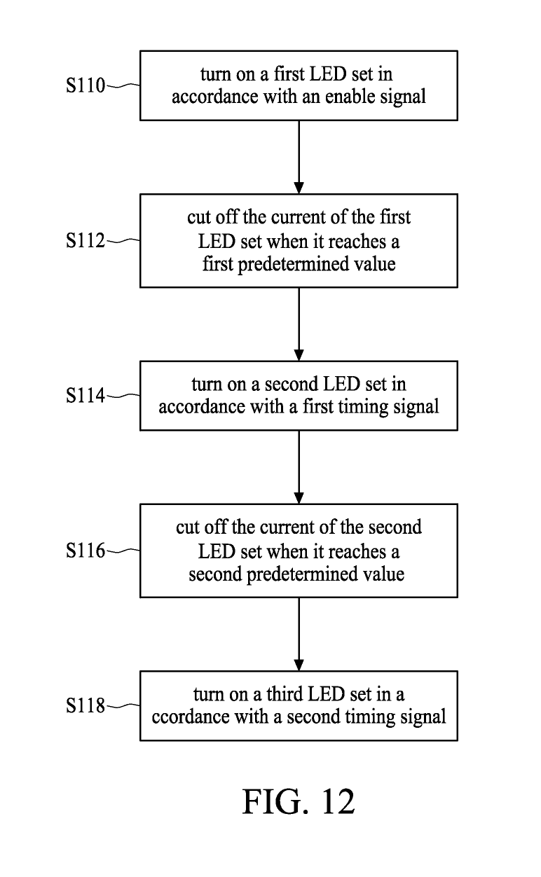

FIG. 12 shows a flow chart of serially turning on the LED array in accordance with one embodiment of the present invention, where the LED array receives a DC power supply as its input power. In step S110, a first LED set is turned on in accordance with an enable signal. In step S112, when the current of the first LED set reaches a first predetermined value, the current of the first LED set is cut off. In step S114, a second LED set is turned on in accordance with a first timing signal. In step S116, when the current of the second LED set reaches a second predetermined value, the current of the second LED set is cut off. In step S118, a third LED set is turned on in accordance with a second timing signal. It is noted that the number of the LED components connected in series in the first, second and third LED sets is in descending order or ascending order.

The following describes the operations of the structure in FIG. 11. First, the LED array 102 receives a DC power V_{DC} as its input power. Next, the turn-on sequence of the LED bars 106, 107 and 108 of the LED array 102 is determined by the enable signal EN outputted by the driving circuit 104 and clock signals OUT₀, OUT₁, . . . , OUTₙ, not by the amplitude of the DC power V_{DC}. When the current of the first LED bar reaches a predetermined value, e.g., a fixed current and a fixed turn-on duration, the current of the LED bar is cut off.

In the above embodiments, adjusting the brightness of the LED bars or LED sets in the LED array 102 is performed by changing the fixed current or changing the fixed turn-on duration. However, to further reduce the power loss of the lighting apparatus, when the LED array 102 is to be dimmed, the LED bars or LED sets maintain a fixed turn-on duration but only change the magnitude of the driving current, thereby achieving the purpose of dimming or mixing RGB colors.

The above-described embodiments of the present invention are intended to be illustrative only. Numerous alternative embodiments may be devised by persons skilled in the art without departing from the scope of the following claims.

What is claimed is:

1. A lighting apparatus receiving a regulated alternating current (AC) power as an input power, the lighting apparatus comprising:
a light emitting diode (LED) array having a plurality of LED sets connected in parallel; and
a driving circuit including a plurality of outputs corresponding to the LED sets, and each of the outputs having a predetermined value to control the brightness of the corresponding LED set;
wherein each of the LED sets is turned on in sequence in accordance with the output of the driving circuit and the amplitude of the regulated AC power, and is turned off in accordance with the predetermined value.

2. The lighting apparatus of claim 1, wherein the LED set is assembled with one to three LED bars connected in parallel, and the one to three LED bars are assembled with a plurality of LED components connected in series.

3. The lighting apparatus of claim 2, wherein the LED set is turned on when the corresponding output of the driving circuit is enabled and the amplitude of the AC power is greater than the voltage drop of the LED components connected in series in the LED set and the voltage drop between the output of the driving circuit and a reference voltage.

4. The lighting apparatus of claim 1, wherein the predetermined value is a fixed current value and a fixed turn-on duration.

5. The lighting apparatus of claim 2, wherein each of the LED sets is turned on only in a partially positive voltage cycle of the AC power.

6. The lighting apparatus of claim 2, wherein the LED sets are arranged in accordance with the number of LED components in the LED set in ascending order.

7. The lighting apparatus of claim 2, wherein the LED sets are arranged in accordance with the number of LED components in the LED set in descending order.

8. The lighting apparatus of claim 2, wherein the pattern of the LED array is shaped as one of rectangle, triangle and sine wave.

9. The lighting apparatus of claim 2, wherein the LED set further comprises a resistor or a switch coupled to the AC power and driving circuit.

10. The lighting apparatus of claim 1, wherein the driving circuit adjusts the frequency of the outputs by a synchronous tracking unit.

11. The lighting apparatus of claim 10, wherein the driving circuit adjusts the sequence of the outputs by the synchronous tracking unit.

12. The lighting apparatus of claim 1, wherein the predetermined value corresponds to a fixed turn-on duration, and the current of the predetermined value is adjustable to conduct dimming and mixing of RGB lights.

13. A lighting apparatus receiving a direct current (DC) power as an input power, the lighting apparatus comprising:
a light emitting diode (LED) array having a plurality of LED sets connected in parallel; and
a driving circuit including a plurality of outputs corresponding to the LED sets to control the brightness of the corresponding LED set;
wherein each of the LED sets is selectively turned on in accordance with the output of the driving circuit and is cut off in accordance with a predetermined value of the output of the driving circuit, and the LED sets are arranged in accordance with the number of LED components in the LED set in descending order or ascending order.

14. The lighting apparatus of claim 13, wherein the LED set is assembled with one to three LED bars connected in parallel, and the one to three LED bars are assembled with a plurality of LED components connected in series.

15. The lighting apparatus of claim 14, wherein the LED set is turned on in accordance with an enable signal or a timing signal.

16. The lighting apparatus of claim 13, wherein the predetermined value is a fixed current value and a fixed turn-on duration.

17. The lighting apparatus of claim 13, wherein the pattern of the LED array is shaped as one of rectangle, triangle and sine wave.

18. The lighting apparatus of claim 13, wherein the LED set further comprises a resistor or a switch coupled to the DC power and driving circuit.

19. The lighting apparatus of claim 13, wherein the predetermined value corresponds to a fixed turn-on time, and the current of the predetermined value is adjustable to conduct dimming and mixing of RGB lights.

20. A lighting method for turning on a light emitting diode (LED) array in sequence, the LED array receiving a regulated alternating current (AC) power as an input power, and the LED array having a plurality of LED sets connected in parallel, the method comprising the steps of:
providing a first LED set with a first driving signal;
turning on the first LED set in accordance with a first amplitude of the AC power;
cutting off the current of the first LED set when the current of the first LED set reaches a first predetermined value;
providing a second LED set with a second driving signal;
turning on the second LED set in accordance with a second amplitude of the AC power; and
cutting off the current of the second LED set when the current of the second LED set reaches a second predetermined value;
wherein the number of LED components in the first LED set is less than the number of LED components in the second LED set when the first amplitude is less than the second amplitude, and the number of LED components in the first LED set is greater than the number of LED components in the second LED set when the first amplitude is greater than the second amplitude.

21. The lighting method of claim 20, wherein the first and second driving signals have a fixed current value and a fixed turn-on duration.

22. The lighting method of claim 20, wherein the first or second LED set is turned on when the first or the second LED set receives the first or second driving signal, and the first or second amplitude of the AC power is greater than the voltage drop of the LED components connected in series in the first or second LED set and the voltage drop between the output of the driving circuit and a reference voltage.

23. The lighting method of claim 21, wherein the first and second predetermined values are a fixed current value and a fixed turn-on duration of the first and second driving signals, respectively.

24. The lighting method of claim 20, wherein the first and second LED sets are turned on only in a partially positive voltage cycle of the AC power.

25. The lighting method of claim 20, further comprising detecting a turn-on status of the first LED set to synchronously track the cycle of the AC power, thereby adjusting the operating frequency of the first and second driving signals.

26. The lighting method of claim 20, further comprising detecting the voltage difference of the first LED set to synchronously track the amplitude of the AC power, thereby adjusting a turn-on sequence of the first and second driving signals.

27. The lighting method of claim 23, wherein the first and second driving signals have a fixed turn-on duration, and the current of the first and second driving signals is adjustable to conduct dimming or mixing of RGB lights.

28. A lighting method for turning on a light emitting diode (LED) array in sequence, the LED array receiving a direct current (DC) power as an input power, and the LED array having a plurality of LED sets connected in parallel, the method comprising the steps of:
turning on a first LED set in accordance with an enable signal;
cutting off the current of the first LED set when the current of the first LED set reaches a first predetermined value;
turning on a second LED set in accordance with a first timing signal;
cutting off the current of the second LED set when the current of the second LED set reaches a second predetermined value; and
turning on a third LED set in accordance with a second timing signal;
wherein the number of LED components connected in series in the first, second and third LED sets is in descending order or ascending order.

29. The lighting method of claim 28, wherein the first and second predetermined values are a fixed current value and a fixed turn-on duration, respectively.

30. The lighting method of claim 28, wherein the first and second predetermined values have a fixed turn-on duration, and the current of the first and second predetermined values is adjustable to conduct dimming and mixing of RGB lights.
